(19) United States
(12) Patent Application Publication
(10) Pub. No.: US 2019/0324696 A1
(43) Pub. Date: Oct. 24, 2019

(54) IMAGE FORMING APPARATUS, TRAY DETERMINATION METHOD, AND COMPUTER PROGRAM

(71) Applicant: KONICA MINOLTA, INC., Tokyo (JP)

(72) Inventors: Hideyuki Matsuda, Osaka (JP); Yusuke Mikoshiba, Toyokawa-shi (JP); Tatsunori Okada, Toyokawa-shi (JP); Yoshikazu Takesada, Inagawa-cho (JP); Yuji Kawamura, Toyokawa-shi (JP)

(73) Assignee: KONICA MINOLTA, INC., Tokyo (JP)

(21) Appl. No.: 16/297,882

(22) Filed: Mar. 11, 2019

(30) Foreign Application Priority Data
Apr. 2, 2018 (JP) 2018-070790

(51) Int. Cl. G06F 3/12; H04N 1/00

(52) U.S. Cl. CPC G06F 3/1215; G06F 3/1257; H04N 1/00636; H04N 1/00708

(57) ABSTRACT

An image forming apparatus includes: a plurality of trays in which sheets are set; a printer; and a hardware processor that determines a first tray, which is one tray of the plurality of trays, in preference to a second tray, which is another tray of the plurality of trays, among the plurality of trays as a feed source tray feeding the sheets to the printer in a state where first sheets of which types are determined are set in the first tray as the sheets, second sheets of which types are not determined are set in the second tray as the sheets, and both the first and second sheets are capable of satisfying a condition allowing an image to be printed.

The entire disclosure of Japanese patent Application No. 2018-070790, filed on Apr. 2, 2018, is incorporated herein by reference in its entirety.

### BACKGROUND

### Technological Field

The present invention relates to a technique that determines a tray feeding a sheet to be used for printing.

### Description of the Related Art

An image forming apparatus, which is referred to as “multi-function printer” or “multi function peripherals (MFPs)”, has spread in the past.

The image forming apparatus can print images on various types of sheets (for example, plain paper, thin paper, a cardboard, and the like). Meanwhile, it is preferable that a user checks the type of a sheet on which an image is to be printed in advance and designates the type in the image forming apparatus to obtain a higher-quality printed matter. Then, the image forming apparatus prints an image under a condition suitable for the designated sheet. However, these operations are troublesome for a user.

For this reason, a sensor for detecting the type of a sheet, which is being conveyed, is provided in the image forming apparatus, and the type of a sheet, which is being conveyed, is detected by the sensor by the time processing for printing an image on the sheet starts.

An image forming apparatus disclosed in JP 2017-193390 A includes a thickness output unit that is provided on the upstream side of a position where an image is formed on a sheet by an image forming unit provided on a conveying path and detects thickness index values, which are index values of the thickness of the sheet, at a plurality of detection positions arranged in a width direction with respect to the conveying direction of a sheet, and outputs the thickness index values. Further, a determination unit performs envelope-determination of determining the sheet as an envelope, in a case where the thickness index values obtained at the plurality of detection positions arranged in the width direction of the sheet are different values.

In a case where the detection of the type of a sheet is adapted to be performed before printing, time required until the completion of printing is increased with the detection of the type. As a result, the number of sheets, which can be printed per unit time, may be reduced. This problem cannot be solved in the image forming apparatus disclosed in JP 2017-193390 A.

### SUMMARY

The present invention has been made in consideration of this problem, and an object of the present invention is to make time, which is required until the completion of printing after the reception of a print command in an image forming apparatus capable of detecting the type of a sheet before printing, shorter than that in the related art.

To achieve the abovementioned object, according to an aspect of the present invention an image forming apparatus reflecting one aspect of the present invention comprises: a plurality of trays in which sheets are set; a printer, and a hardware processor that determines a first tray, winch is one tray of the plurality of trays, in preference to a second tray, which is another tray of the plurality of trays, among the plurality of trays as a feed source tray feeding the sheets to the printer in a state where first sheets of which types are determined are set in the first tray as the sheets, second sheets of which types are not determined are set in the second tray as the sheets, and both the first and second sheets are capable of satisfying a condition allowing an image to be printed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of the appearance of an image forming apparatus;

FIG. 2 is a diagram illustrating an example of the hardware configuration of the image forming apparatus;

FIG. 3 is a diagram illustrating an example of the hardware configuration of a sheet feed unit;

FIG. 4 is a diagram illustrating an example of the functional configuration of the image forming apparatus;

FIGS. 5A to 5C are diagrams illustrating examples of sheet information;

FIG. 6 is a flowchart illustrating an example of the flow of first determination processing;

FIG. 7 is a flowchart illustrating an example of the flow of second determination processing;

FIG. 8 is a diagram illustrating an example of the flow of the entire processing of the image forming apparatus;

FIG. 9 is a diagram illustrating an example of sheet information in a case where sheet shortage occurs;

FIGS. 10A to 10D are diagrams illustrating examples of sheet information in automatic sheet-type detection processing;

FIG. 11 is a diagram illustrating an example of an administrator screen;

FIGS. 12A and 12B are diagrams illustrating examples of a job settings screen and an advanced settings screen; and

FIG. 13 is a diagram illustrating an example of an administrator screen.

### DETAILED DESCRIPTION OF EMBODIMENTS

Hereinafter, one or more embodiments of the present invention will be described with reference to the drawings. However, the scope of the invention is not limited to the disclosed embodiments.

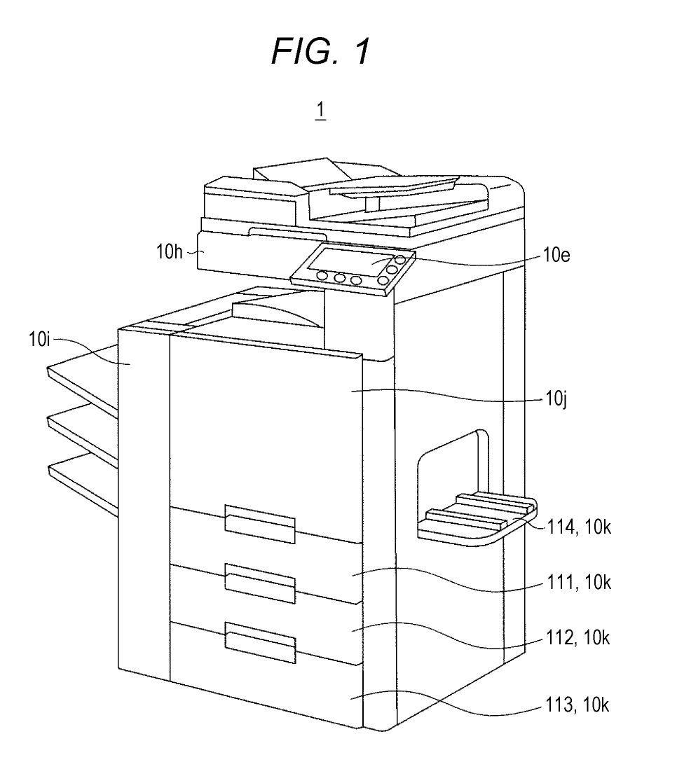

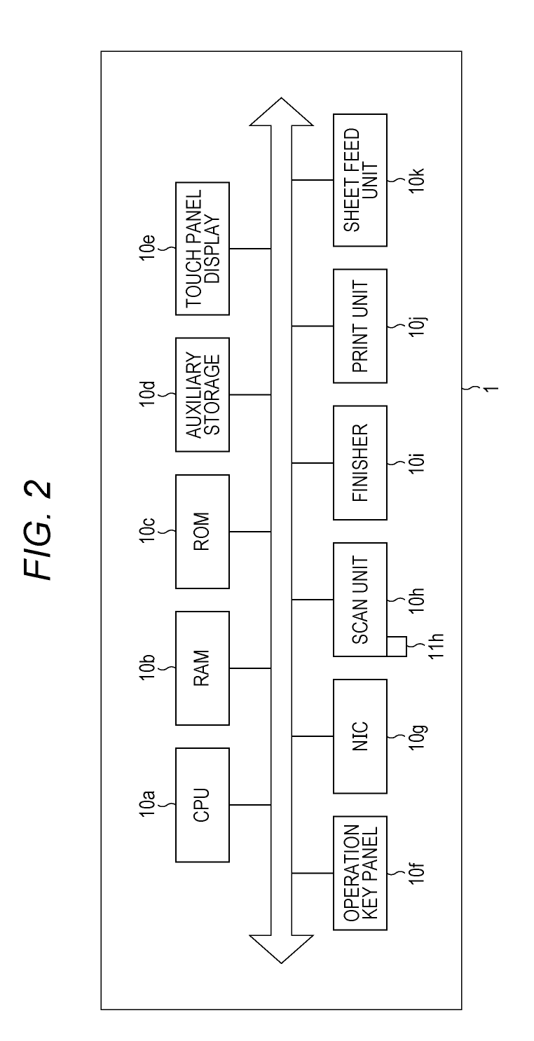

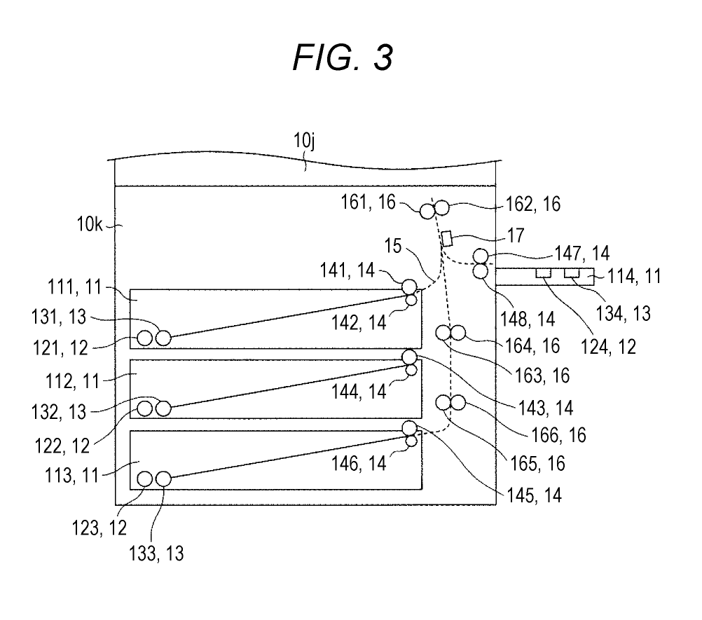

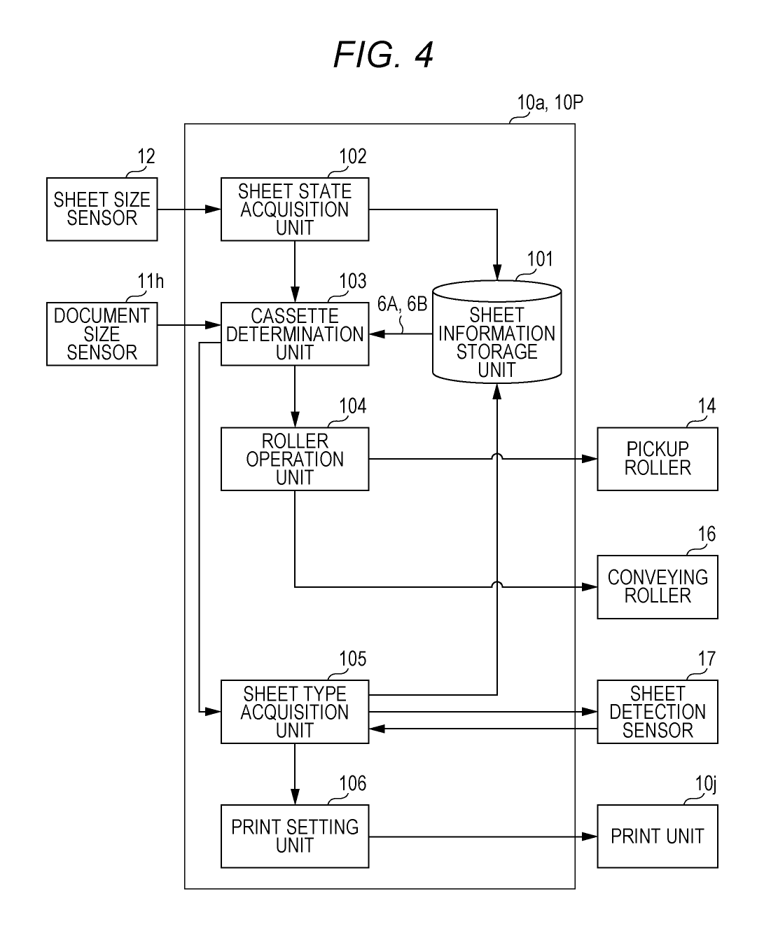

FIG. 1 is a diagram illustrating an example of the appearance of an image forming apparatus 1. FIG. 2 is a diagram illustrating an example of the hardware configuration of the image forming apparatus 1. FIG. 3 is a diagram illustrating an example of the hardware configuration of a sheet feed unit 10k. FIG. 4 is a diagram illustrating an example of the functional configuration of the image forming apparatus 1.

The image forming apparatus 1 illustrated in FIG. 1 is an apparatus where the functions of copying. PC print, cloud print, a fax, a scanner, a box, and the like are integrated. Generally, the image forming apparatus 1 may be referred to as a “multi-function printer”, “multi function peripherals (MFPs)”, or the like.

A PC print function is a function to print an image on a sheet on the basis of image data received from a terminal device that is present on the same local area network (LAN) as the image forming apparatus 1. The PC print function is also referred to as “network printing”, “network print”, or the like.

A cloud print function is a function to receive image data from an external terminal device through a server present on the Internet and to print an image on a sheet.

A box function is a function to provide a storage area, which is referred to as a “box”, a “personal box”, or the like, for each user and to allow the user to store and manage image data and the like by one's own storage area. A box can be provided for each group and can also be shared by members of the group. The box corresponds to a “folder” or a “directory” in a personal computer.

As illustrated in FIG. 1 or 2, the image forming apparatus 1 includes a central processing unit (CPU) 10a, a random access memory (RAM) 10b, a read only memory (ROM) 10c, an auxiliary storage 10d, a touch panel display 10e, an operation key panel 10f, a network interface card (NIC) 10g, a scan unit 10h, a finisher 10i, a print unit 10j, a sheet feed unit 10k, and the like.

The CPU 10a is the main CPU of the image forming apparatus 1. The RAM 10b is the main memory of the image forming apparatus 1.

The touch panel display 10e displays a screen that shows a message for a user, a screen to which a user inputs commands or information, a screen that shows the result of processing performed by the CPU 10a, and the like. In addition, the touch panel display 10e sends a signal representing a touched position to the CPU 10a.

The operation key panel 10f is a so-called hardware keyboard, and includes numeric keypad, a start key, a stop key, a function key, and the like.

The NIC 10g communicates with other devices with protocol, such as transmission control protocol/internet protocol (TCP/IP).

The scan unit 10h reads an image, which is recorded on a document (sheet) set on an auto document feeder (ADF) or platen glass, and generates image data. Further, the scan unit 10h is provided with a document size sensor 11h that detects the size of the document.

The finisher 10i performs post-treatment on printed matters, which are obtained from the print unit 10j, as necessary. The post-treatment is treatment for stapling printed matters, treatment for punching printed matters, treatment for folding printed matters, or the like.

The print unit 10j prints an image, which is represented by the image data received from an external device through the NIC 10g, on a sheet in addition to the image that is read by the scan unit 10h.

The sheet feed unit 10k is a unit that is used to feed a sheet to the print unit 10j. As illustrated in FIG. 3, the sheet feed unit 10k includes cassettes 111, 112, 113, and 114, sheet size sensors 121, 122, 123, and 124, residual quantity sensors 131, 132, 133, and 134, pickup rollers 141, 142, 143, 144, 145, 146, 147, and 148, a conveying path 15, conveying rollers 161, 162, 163, 164, 165, and 166, a sheet detection sensor 17, and the like.

The cassettes 111 to 114 will be generically referred to as “cassettes 11”. The sheet size sensors 121 to 124 will be generically referred to as “sheet size sensors 12”. The residual quantity sensors 131 to 134 will be generically referred to as “residual quantity sensors 13”. The pickup rollers 141 to 148 will be generically referred to as “pickup rollers 14”. The conveying rollers 161 to 166 will be generically referred to as “conveying rollers 16”.

Meanwhile, the “cassette” may be generally referred to as a “tray” or a “sheet feeding tray”.

Sheets are set in the cassette 111. Further, the cassette 111 is provided with the sheet size sensor 121, the residual quantity sensor 131, and the pickup rollers 141 and 142. The sheet size sensor 121 detects the size of the set sheet. The residual quantity sensor 131 detects the residual quantity of the set sheets. The pickup rollers 141 and 142 pick up the set sheets one by one and carry the set sheets to the conveying path 15.

As with the cassette 11, sheets are also set in each of the cassettes 112 and 113. Further, as the same means, the cassette 112 is provided with the sheet size sensor 122, the residual quantity sensor 132, and the pickup rollers 143 and 144 and the cassette 113 is provided with the sheet size sensor 123, the residual quantity sensor 133, and the pickup rollers 145 and 146.

Meanwhile, names of “cassette 01”, “cassette 02”, and “cassette 03” are given to the cassettes 111, 112, and 113, respectively, to allow a user to easily identify the cassettes.

Sheets are set in the cassette 114 by manual feed. The cassette 114 may be generally referred to as a “manual feed tray”. Further, a manual feed tray without a lid, that is, an opened manual feed tray may be used as the cassette 114 as illustrated in FIG. 1 or 3. Furthermore, the cassette 114 may be adapted to be capable of being attached to and detached from the image forming apparatus 1 or to be capable of being folded in a state where sheets are not set in the cassette 114.

The sheet to be set in the cassette 114 is a sheet having a size that does not allow the sheet to be stored in the cassettes 111 to 113 or a sheet of which the frequency of use is relatively low, such as a color sheet or a backing sheet.

The cassette 114 is provided with a movable conveyance guide that is used to position the set sheets, the sheet size sensor 124 that detects the size of the set sheet, and the residual quantity sensor 134 that detects the residual quantity of the set sheets. The pickup rollers 147 and 148 pick up the set sheets one by one from the cassette 114 and carry the set sheets to the conveying path 15. Meanwhile, a name of “cassette 04” is given to the cassette 114.

The conveying path 15 and the conveying rollers 16 convey a sheet, which is carried out of the cassette 11, to the print unit 10j.

The sheet detection sensor 17 is a transmission-type ultrasonic sensor. The sheet detection sensor 17 is provided on the conveying path 15, and applies ultrasonic waves from the front side of a sheet and receives ultrasonic waves on the back side of the sheet to detect the type of the sheet (for example, plain paper, a cardboard, or the like) that is conveyed. Hereinafter, the type of a sheet may be described as a “sheet type”.

Meanwhile, as long as a position where the sheet detection sensor 17 is provided is a position on the upstream side of a secondary transfer roller in the print unit 10j, the position where the sheet detection sensor 17 is provided may be a position other than the conveying path 15.

An application, which is used to fulfill the above-mentioned functions of copying and the like, is stored in the ROM 10c or the auxiliary storage 10d. In addition, a cassette determination program 10P (see FIG. 4) is stored in the ROM 10c or the auxiliary storage 10d.

The cassette determination program 10P is a program that is used to determine a cassette (hereinafter, described as a “feed source cassette”) feeding a sheet to execute a job in a case where a certain job is received. The details of the cassette determination program 10P will be described later.

These programs are loaded to the RAM 10b and are executed by the CPU 10a. A hard disk drive, a solid state drive (SSD), or the like is used as the auxiliary storage 10d.

According to the cassette determination program 10P, a sheet information storage unit 101 to a print setting unit 106 illustrated in FIG. 4 are realized in the image forming apparatus 1.

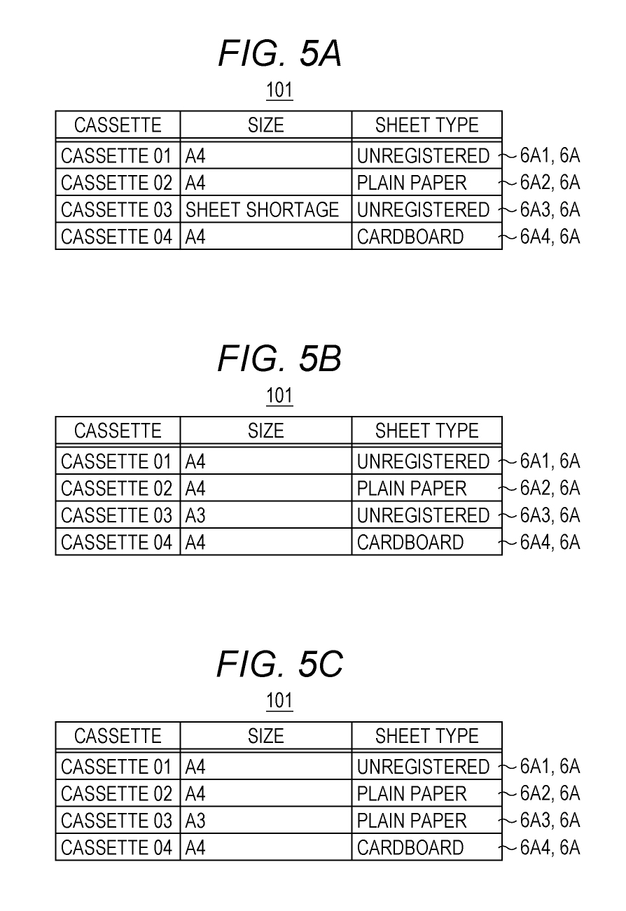

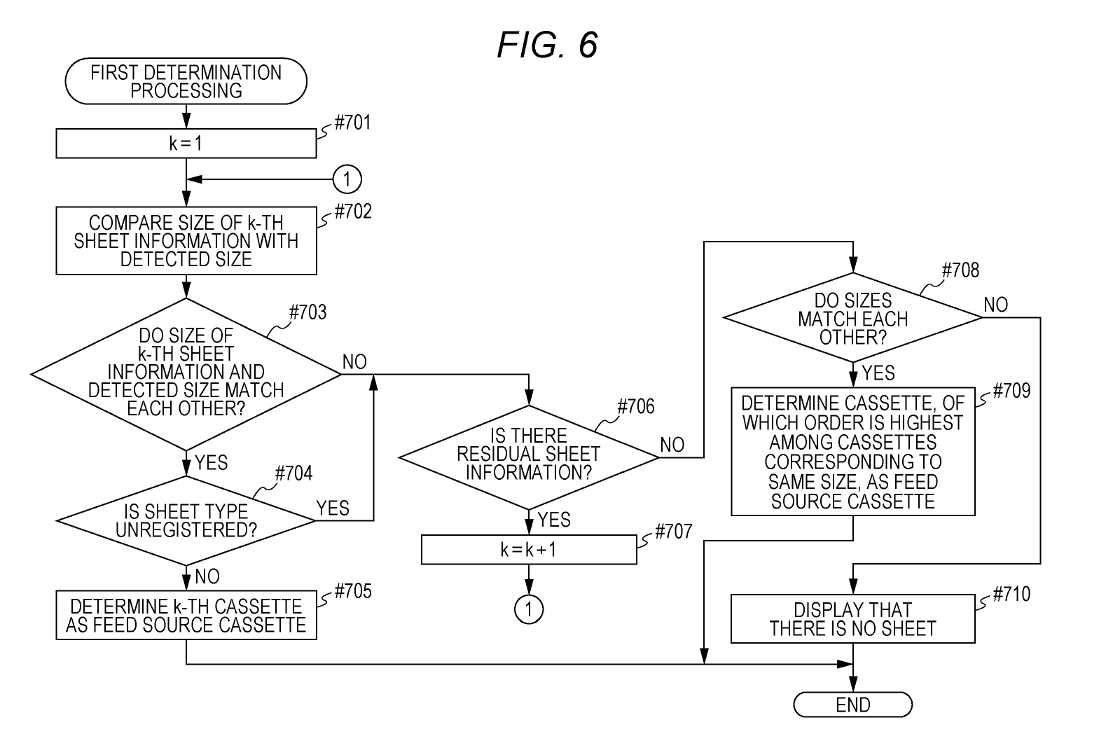

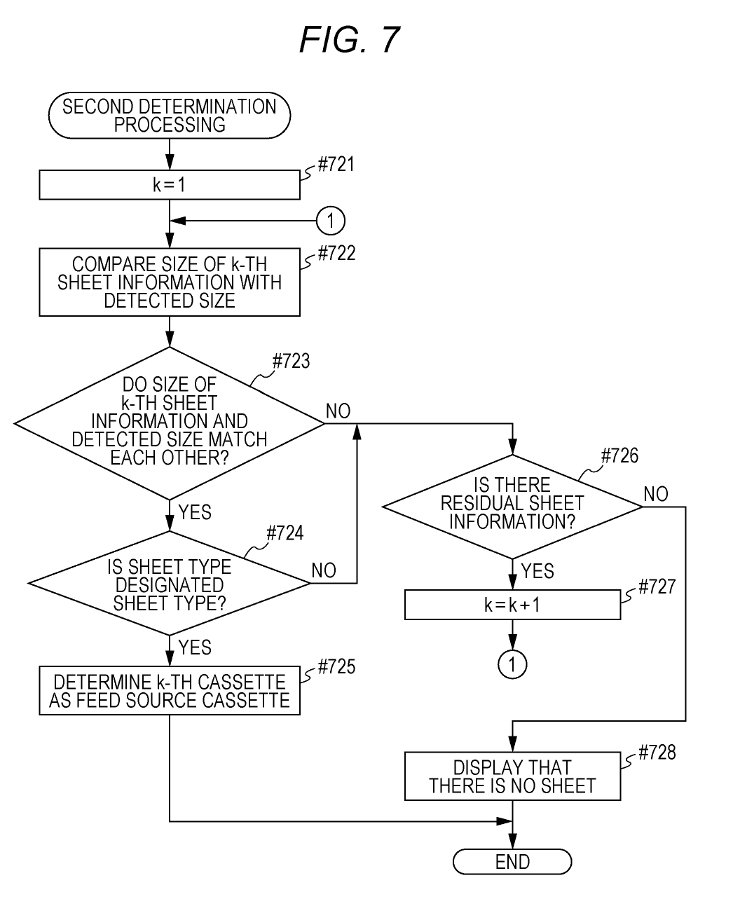

FIGS. 5A to 5C are diagrams illustrating examples of sheet information 6A. FIG. 6 is a flowchart illustrating an example of the flow of first determination processing. FIG. 7 is a flowchart illustrating an example of the flow of second determination processing. The operations of the sheet information storage unit 101 to the print setting unit 106 will be described with reference to FIGS. 4 to 7 using a case where a user copies an A3 document first and then copies an A4 document as an example.

Sheet information 6A, which represents the size and the sheet type of a set sheet, illustrated in FIGS. 5A to 5C is stored for each of the cassettes 111 to 114 in the sheet information storage unit 101.

The sheet information of the cassette 111, the cassette 112, the cassette 113, and the cassette 114 will be described below as “sheet information 6A1”, “sheet information 6A2”, “sheet information 6A3”, and “sleet information 6A4”. Meanwhile, the sheet information 6A1, the sheet information 6A2, the sheet information 6A3, and the sheet information 6A4 are in a state illustrated in FIG. 5A immediately before a user copies an A3 document.

In the example of FIG. 5A, the sheet information 6A2 represents that the size of a sheet set in the cassette 112 is “A4” and a sheet type is “plain paper”.

However, there is a cassette where sheets are not set. In this case, “sheet shortage” and “unregistered” are represented as a size and a sheet type as in the sheet information 6A3.

Further, in a case where sheets are set but a sheet type is not yet determined, “unregistered” is represented as a sheet type as in the sheet information 6A1.

Order information 6B is further stored in the sheet information storage unit 101. The order information 6B is an order about the cassettes 11 and represents the order of processing for determining whether or not a cassette is appropriate for the feed source cassette. In this example, a high order is set in the sequence of the cassettes 111, 112, 113, and 114.

In this example, it is thought that a user wants to copy an image of the A3 document to a sheet as A3 plain paper first. However, A3 sheets are not set in any of the cassettes 11 (see FIG. 5A). Accordingly, the user sets A3 plain paper in the cassette 113 that is the cassette 11 corresponding to sheet shortage.

Then, the residual quantity sensor 133 detects the residual quantity of the sheets of the cassette 113. The sheet size sensor 123 detects that the size of the sheet set in the cassette 113 is A3.

A sheet state acquisition unit 102 receives the detection results of the sheet size sensors 12, and updates “sizes” of the sheet information 6A of the cassettes 11 of the sheet size sensors 12 on the basis of the results of the sheet size sensors 12.

In this example, the sheet state acquisition unit 102 receives the detection result of the sheet size sensor 123. As shown in FIG. 5B, the sheet state acquisition unit 102 updates “size” of the sheet information 6A3 to “A3” from “sheet shortage”.

After that, the user sets the A3 document on the ADF of the scan unit 10h. Then, the document size sensor 11h detects the size of the document that is set on the ADF. In this example, the document size sensor 11h detects that the size of the document is A3.

After that, the user instructs the image forming apparatus 1 to execute a copy job. Then, the following processing is performed.

A cassette determination unit 103 receives the detection result of the document size sensor 11h. The cassette determination unit 103 determines a feed source cassette according to a procedure illustrated in FIG. 6 on the basis of the received result. Processing according to this procedure may be described as “first determination processing”.

The cassette determination unit 103 pays attention to the sheet information 6A of which an order represented in the order information 6B is the first place (#701 of FIG. 6). The cassette determination unit 103 compares the size represented in the sheet information 6A to which the cassette determination unit 103 pays attention with the size that is detected by the document size sensor 11h (#702).

If the size represented in the sheet information 6A and the size detected by the document size sensor 11h match each other (Yes in #703) and the sheet type represented in the sheet information 6A is not “unregistered” (No in #704), the cassette determination unit 103 determines the cassette 11 corresponding to the sheet information 6A as a feed source cassette (#705). Then, the cassette determination unit 103 ends the first determination processing.

On the other hand, if the size represented in the sheet information 6A and the size detected by the document size sensor 11h do not match each other (No in #703) or the sheet type represented in the sheet information 6A is “unregistered” (Yes in #704), the cassette determination unit 103 newly pays attention to the sheet information 6A of which the order is second highest (#707) in a case where pieces of sheet information 6A to which the cassette determination unit 103 does not pay attention remain (Yes in #706), returns to Step #702, and performs the above-mentioned processing.

In this way, the cassette determination unit 103 searches for the cassettes 11 in which sheets of which the sizes are equal to the size of the document set on the ADF and the sheet types are already detected are set, until the cassettes 11 are found in decreasing order. Then, when one of these cassettes 11 is found, the cassette determination unit 103 ends the search and determines the found cassette 11 as a feed source cassette.

However, there is a case where such a cassette 11 is not found at all. If pieces of sheet information 6A representing a size equal to the size detected by the document size sensor 11h are present (Yes in #708) in this case (No in #706), the cassette determination unit 103 determines a cassette 11, of which the order is highest among the cassettes 11 corresponding to the pieces of sheet information 6A, as a feed source cassette (#709). If this sheet information 6A is not present (No in #708), the cassette determination unit 103 does not determine a feed source cassette, causes the touch panel display 10e to display that there is no sheet having a size matching the size of the document, and stops copying (#710). Accordingly, the first determination processing ends.

In this example, the cassette determination unit 103 receives the detection result of the document size sensor 11h. The cassette determination unit 103 searches for the sheet information 6A of which “size” is “A3” according to the order information 6B. The sheet information 6A3 is found, but “sheet type” of the sheet information 6A3 is “unregistered”. For this reason, the cassette determination unit 103 continues to search for the sheet information 6A of which “size” is “A3”. As a result of completion of search of the sheet information 6A, only one piece of sheet information 6A (sheet information 6A3) of which “size” is “A3” is found. Accordingly, the cassette determination unit 103 determines the cassette 11 corresponding to the sheet information 6A3, that is, the cassette 113 as a feed source cassette.

In a case where a feed source cassette is determined by the cassette determination unit 103, a roller operation unit 104 operates the pickup rollers 14 and the conveying rollers 16 so that a sheet is conveyed from the feed source cassette to the print unit 10j through the conveying path 15.

At this time, in a case where “sheet type” of the sheet information 6A of the cassette 11 determined as a feed source cassette (hereinafter, described as “sheet information 6A of the feed source cassette”) is “unregistered”, the roller operation unit 104 operates the pickup rollers 14 and the conveying rollers 16 so that a sheet is conveyed at a speed lower than a normal speed. This is to allow the sheet detection sensor 17 to more reliably detect the sheet type of a conveyed sheet.

Meanwhile, in a case where a plurality of sheets are carried out of one cassette 11 (for example, in a case where a plurality of sheets are copied), the roller operation unit 104 has only to cause the first sheet to be conveyed at a low speed only when the first sheet passes through the sheet detection sensor 17.

Since “sheet type” of the sheet information 6A3 is “unregistered” in this example, the roller operation unit 104 operates the pickup rollers 145 and 146 and the conveying rollers 16 so that the first sheet is conveyed at a speed lower than a normal speed.

A sheet type acquisition unit 105 gives a command, which detects the sheet type of a sheet to be conveyed, to the sheet detection sensor 17 in a case where “sheet type” of the sheet information 6A of the feed source cassette is “unregistered” when the pickup rollers 14 and the conveying rollers 16 start to be operated by the roller operation unit 104.

In a case where the command is given to the sheet detection sensor 17 from the sheet type acquisition unit 105, the sheet detection sensor 17 detects the sheet type of the sheet when the sheet passes through the sheet detection sensor 17. The sheet detection sensor 17 sends the detection result thereof to the sheet type acquisition unit 105.

The sheet type acquisition unit 105 receives the detection result of the sheet detection sensor 17, and updates “sheet type” of the sheet information 6A of the feed source cassette on the basis of the result of the sheet detection sensor 17.

Meanwhile, in a case where a plurality of sheets are carried out of one cassette 11, the sheet type acquisition unit 105 has only to give the command to the sheet detection sensor 17 so that the sheet detection sensor 17 detects the sheet type of the first sheet only when the first sheet passes through the sheet detection sensor 17.

Since “sheet type” of the sheet information 6A3 is “unregistered” in this example, the sheet type acquisition unit 105 gives a command, which detects the sheet type of a sheet to be conveyed, to the sheet detection sensor 17. The sheet detection sensor 17 detects that the sheet type of the sheet is plain paper. The sheet type acquisition unit 105 receives the detection result of the sheet detection sensor 17. Then, as illustrated in FIG. 5C, the sheet type acquisition unit 105 updates “sheet type” of the sheet information 6A3 to “plain paper” from “unregistered”.

The print setting unit 106 makes setting, which is to perform printing under a condition corresponding to “sheet type” of the sheet information 6A of the feed source cassette, for the print unit 10j.

In this example, the print setting unit 106 makes setting, which is to perform printing under a condition corresponding to plain paper as “sheet type” of the sheet information 6A3 of the feed source cassette, for the print unit 10j. For example, the print setting unit 106 adjusts the temperature or speed of a fixing roller to a temperature or a speed corresponding to plain paper.

After that, an image is printed on a sheet according to a set condition by the print unit 10j.

Then, the user tries copying the image of the A4 document to an A4 sheet. The user sets the A4 document on the ADF of the scan unit 10h. Then, the document size sensor 11h detects that the size of the document set on the ADF is A4.

After that, the user instructs the image forming apparatus 1 to execute a copy job. Then, the following processing is performed.

The cassette determination unit 103 receives the detection result of the document size sensor 11h, and determines a feed source cassette according to a procedure illustrated in the first determination processing (see FIG. 6) on the basis of the received result and the order information 6B.

In this example, a cassette 11 (cassette 112) corresponding to the sheet information 6A (sheet information 6A2) of which the order is highest among pieces of the sheet information 6A of which the size is “A4” and the sheet type is not “unregistered” is determined as a feed source cassette (see FIG. 5C).

The roller operation unit 104 operates the pickup milers 143 and 144 and the conveying rollers 16 so that a sheet is conveyed from the cassette 112 to the print unit 10j through the conveying path 15. Since “sheet type” of the sheet information 6A2 is not “unregistered”, the roller operation unit 104 operates the pickup rollers 143 and 144 and the conveying rollers 16 so that the sheet is conveyed at a normal speed as described above.

Since “sheet type” of the sheet information 6A2 is not “unregistered”, the sheet type acquisition unit 105 does not give a command, which detects the sheet type of a sheet to be conveyed, to the sheet detection sensor 17. Further, the sheet type acquisition unit 105 does not update the sheet information 6A2.

The print setting unit 106 makes setting, which is to perform printing under a condition corresponding to plain paper as “sheet type” of the sheet information 6A2, for the print unit 10j. Then, an image is printed on a sheet by the print unit 10j.

Meanwhile, a user can designate the sheet type of a sheet to be used when instructing a copy job to be executed. In this case, the cassette determination unit 103 determines a feed source cassette according to a procedure illustrated in FIG. 7. Hereinafter, the sheet type, which is designated by the user, will be described as “designated sheet type” and processing according to the procedure illustrated in FIG. 7 may be described as “second determination processing”.

The cassette determination unit 103 pays attention to the sheet information 6A of which an order represented in the order information 6B is the first place (#721 of FIG. 7). The cassette determination unit 103 compares the size represented in the sheet information 6A to which the cassette determination unit 103 pays attention with the size that is detected by the document size sensor 11h (#722).

If the size represented in the sheet information 6A and the size detected by the document size sensor 11h match each other (Yes in #723) and the sheet type represented in the sleet information 6A matches the designated sheet type (Yes in #724), the cassette determination unit 103 determines the cassette 11 corresponding to the sheet information 6A as a feed source cassette (#725). Then, the cassette determination unit 103 ends the second determination processing.

On the other hand, if the size represented in the sheet information 6A and the size detected by the document size sensor 11h do not match each other (No in #723) or the sheet type represented in the sheet information 6A and the designated sleet type do not match each other (No in #724), the cassette determination unit 103 newly pays attention to the sheet information 6A of which the order is second highest (#727) in a case where pieces of sheet information 6A to which the cassette determination unit 103 does not pay attention remain (Yes in #726), returns to Step #722, and performs the above-mentioned processing. However, if this sheet information 6A is not present (No in #726), the cassette determination unit 103 does not determine a feed source cassette, causes the touch panel display 10e to display that there is no sheet having a size and a sheet type matching the size of the document and the designated sheet type, and stops copying (#728). Accordingly, the second determination processing ends.

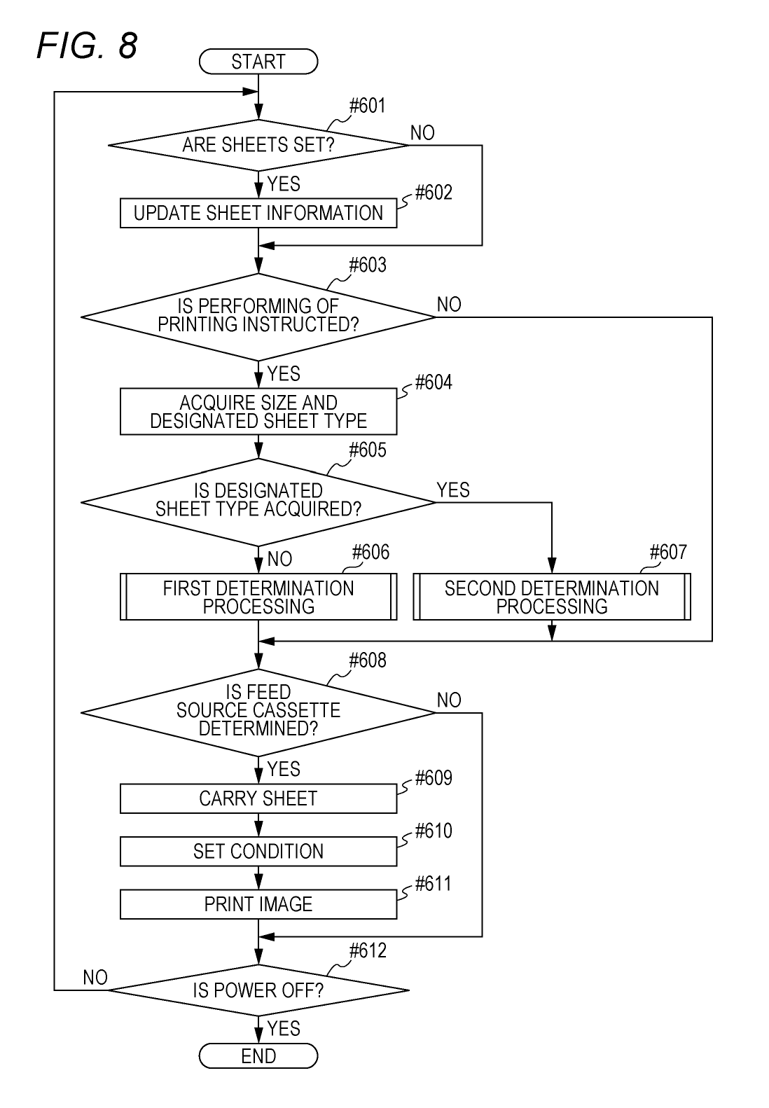

FIG. 8 is a diagram illustrating an example of the flow of the entire processing of the image forming apparatus 1. Next, the flow of the entire processing of the image forming apparatus 1 will be described with reference to flowcharts of FIGS. 6 to 8.

The image forming apparatus 1 performs processing according to a procedure illustrated in FIG. 8 on the basis of the cassette determination program 10P.

If sheets are set in any one of the cassettes 11 (Yes in #601 of FIG. 8), the image forming apparatus 1 detects the residual quantity of the set sheets and the size of each set sheet and updates the sheet information 6A (#602). If the execution of a copy job is instructed from a user (Yes in #603), the image forming apparatus 1 acquires the size of a document and acquires a designated sheet type in a case where the user designates a sheet type (#604).

If the image forming apparatus 1 does not acquire a designated sheet type (No in #605), the image forming apparatus 1 performs the first determination processing (#606). The procedure of the first determination processing is as described above in FIG. 6.

On the other hand, if the image forming apparatus 1 acquire a designated sheet type (Yes in #605), the image forming apparatus 1 performs the second determination processing (#607). The procedure of the second determination processing is as described above in FIG. 7.

If the image forming apparatus 1 determines a feed source cassette in the first determination processing or the second determination processing (Yes in #608), the image forming apparatus 1 carries a sheet out of the feed source cassette (#609) and sets a condition corresponding to the sheet type of the sheet (#610). Then, the image forming apparatus 1 reads an image from the document and prints the image on the sheet (#611). That is, the image forming apparatus 1 copies the image to the sheet.

The image forming apparatus 1 appropriately performs the processing of the above-mentioned steps #601 to #611 until power is off (No in #612).

According to this embodiment, time, which is required until the completion of printing after the reception of a print command in the image forming apparatus 1 capable of detecting the type of a sheet before printing, can be made shorter than that in the related art.

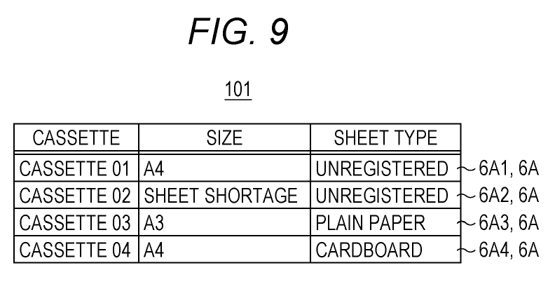

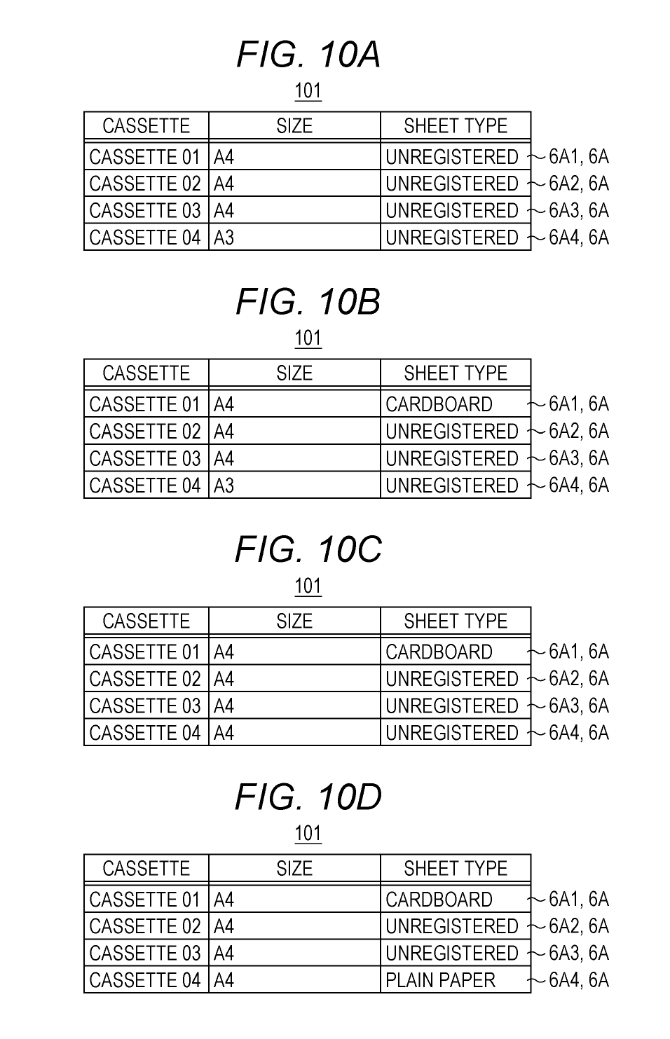

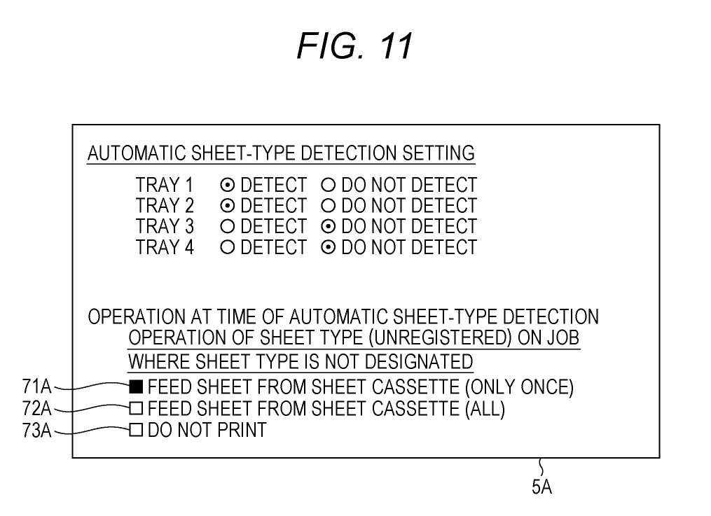

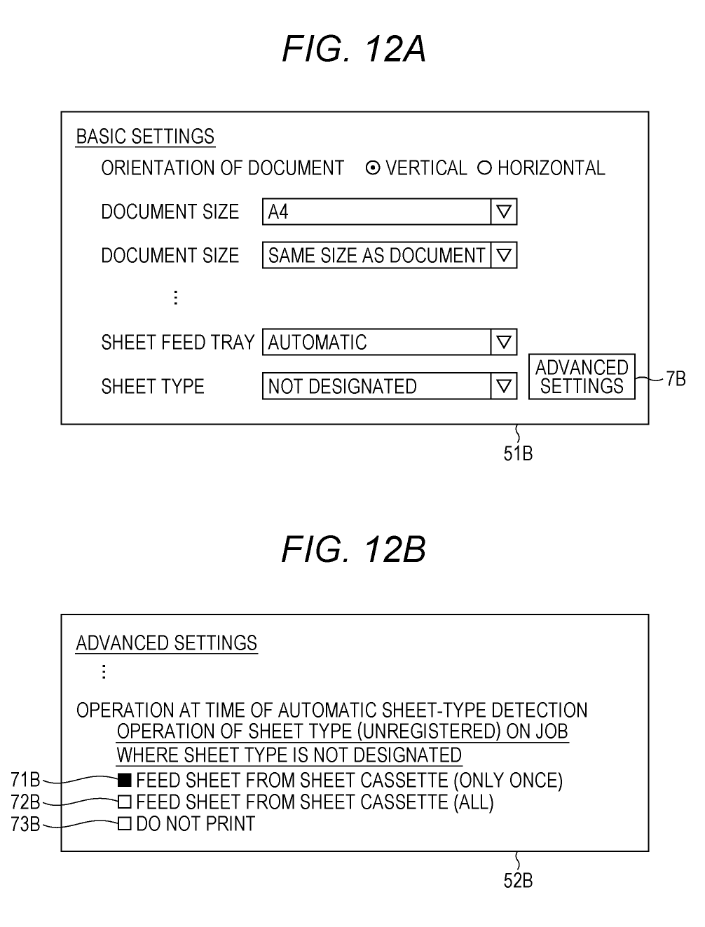

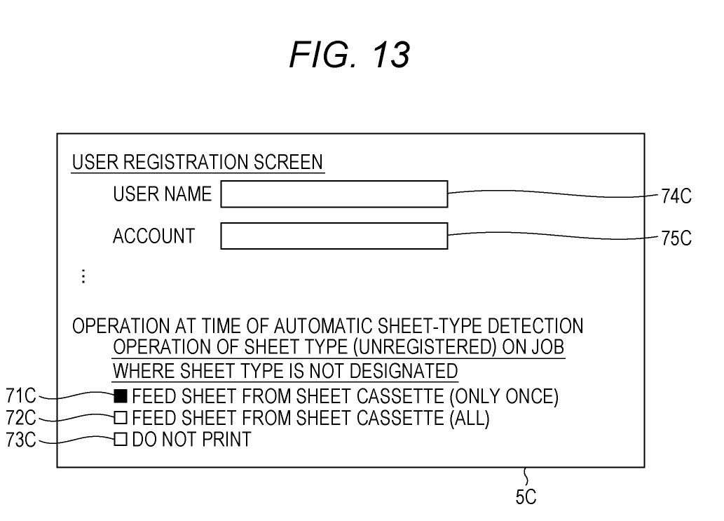

FIG. 9 is a diagram illustrating an example of the sheet information 6A in a case where sheet shortage occurs. FIGS. 10A to 10D are diagrams illustrating examples of the sheet information 6A in automatic sheet-type detection processing. FIG. 11 is a diagram illustrating an example of an administrator screen 5A. FIGS. 12A and 12B are diagrams illustrating examples of a job settings screen 51B and an advanced settings screen 52B. FIG. 13 is a diagram illustrating an example of an administrator screen 5C.

In this embodiment, when any one of the cassettes 11 is detached from a main body of the image forming apparatus 1 by a user, the sheet state acquisition unit 102 may clear the setting of the sheet information 6A of the detached cassette 11 (that is, the sheet state acquisition unit 102 may update “size” to “sheet shortage” and update “sheet type” to “unregistered”). Then, when the cassette 11 is housed in the main body of the image forming apparatus 1, the sheet size sensor 12 of the cassette 11 has only to detect the size of a sheet set in the cassette 11. The sheet state acquisition unit 102 receives the detection result of the sheet size sensor 12, and has only to update “size” of the sheet information 6A on the basis of the result.

A case where printed matters of the document are generated by the execution of a copy job has been described in this embodiment by way of example, but the present invention can also be applied to a case where printed matters of the document are generated by the execution of a PC print job or a cloud print job.

[Occurrence of Sheet Shortage]

In this embodiment, the image forming apparatus 1 may perform the following processing in a case where sheet shortage occurs in the middle of printing.

It is premised that a user has tried copying the image of an A4 document to a plurality of A4 sheets without the designation of a sheet type. Further, it is assumed that the sheet information 6A illustrated in FIG. 5C is stored in the sheet information storage unit 101. Furthermore, it is assumed that the current feed source cassette is the cassette 112.

The residual quantity sensor 132 cannot detect the residual quantity of the sheets of the cassette 112 in a case where sheet shortage occurs on a feed source cassette in the middle of printing.

In a case where the residual quantity sensor 13 of the feed source cassette cannot detect the residual quantity of the sheets, the sleet state acquisition unit 102 updates “size” of the sheet information 6A of the feed source cassette to “sheet shortage” and updates “sheet type” to “unregistered”.

In this example, the sleet state acquisition unit 102 updates “size” of the sheet information 6A2 to “sheet shortage” and updates “sheet type” to “unregistered” as illustrated in FIG. 9.

In a case where the sheet information 6A is updated due to the occurrence of sheet shortage, the cassette determination unit 103 determines a feed source cassette again according to the procedure illustrated in FIG. 6 on the basis of the detection result of the document size sensor 11h and the order information 6B when the execution of the copy job is instructed.

In this example, the cassette determination unit 103 searches for sheet information 6A of which “size” is “A4”. Since the sheet information 6A1 is found first but “sheet type” of the sheet information 6A1 is “unregistered”, the cassette determination unit 103 continues to search for sheet information 6A of which “size” is “A4”. Next, the sheet information 6A4 is found. Since “sheet type” of the sheet information 6A4 is not “unregistered” and is “cardboard”, the cassette determination unit 103 determines the cassette 11 (cassette 114) corresponding to the sheet information 6A4 as a feed source cassette.

The roller operation unit 104 operates the pickup rollers 147 and 148 and the conveying rollers 16 at a normal speed as in this embodiment.

The print setting unit 106 makes setting, winch is to perform printing under a condition corresponding to a cardboard as “sheet type” of the sheet information 6A4, for the print unit 10j. Then, an image is printed on a sheet by the print unit 10j.

[Automatic Sheet-Type Detection Processing]

In this embodiment, in a case where a designated sheet type is acquired (that is, in a case where a user designates the sheet type of a sheet to be used), copying is stopped if “sheet types” of all pieces of the sheet information 6A having the same size and the designated sheet type do not match each other. However, in a case where “sheet type” of any one of all the pieces of the sheet information 6A is “unregistered”, the automatic sheet-type detection processing to be described next may be performed immediately after it is ascertained that “sheet types” of all the pieces of the sheet information 6A having the same size and the designated sheet type do not match each other (that is, No in Step #726 of FIG. 7).

It is premised that a user has tried copying the image of an A4 document to A4 plain paper after designating plain paper as a sheet type (hereinafter, this copy job may be described as “job that is being executed”). Further, sheet information 6A illustrated in FIG. 10A is stored in the sheet information storage unit 101.

The cassette determination unit 103 specifies the sheet information 6A (sheet information 6A1) of which an order represented in the order information 6B is highest among pieces of the sheet information 6A (the sheet information 6A1, the sheet information 6A2, and the sheet information 6A3) of which the sizes match the detection result (A4) of the document size sensor 11h and the sheet types are “unregistered”. The cassette determination unit 103 determines a cassette 11 (cassette 111) corresponding to the specified sheet information 6A as a feed source cassette.

The roller operation unit 104 operates the pickup rollers 14 (pickup rollers 141 and 142) of the feed source cassette and the conveying rollers 16 at a speed lower than a normal speed as in this embodiment.

The sheet type acquisition unit 105 gives a command, which detects the sheet type of a sheet to be conveyed, to the sheet detection sensor 17 as in this embodiment. When the sheet type acquisition unit 105 receives the detection result of the sheet detection sensor 17, the sheet type acquisition unit 105 updates “sheet type” of the sheet information 6A (sheet information 6A1) of the feed source cassette on the basis of the result of the sheet detection sensor 17.

When the sheet information 6A is updated in a case where a designated sheet type is acquired, the print setting unit 106 makes setting, which is to perform printing under a condition corresponding to an updated sheet type, for the print unit 10j if “sheet type” (hereinafter, described as an “updated sheet type”) of the updated sheet information 6A (sheet information 6A1) of the feed source cassette and the designated sheet type match each other. After that, an image is printed on a sheet by the print unit 10j.

If the updated sheet type and the designated sheet type do not match each other, the print setting unit 106 makes setting, which is not to print an image on the sheet having been already carried, for the print unit 10j. Accordingly, the sheet, which has been already carried out of the feed source cassette (cassette 111), is discharged as a blank sheet without being printed. In addition, the print setting unit 106 causes the touch panel display 10e to display that there is no sheet having a sheet type matching the designated sheet type and stops the copy job.

When sheets set in the cassette 111 are plain paper in this example, an image is printed on the sheet. Otherwise, the sheet is discharged as a blank sheet and the job that is being executed is stopped.

Alternatively, if the updated sheet type and the designated sheet type do not match each other, the image forming apparatus 1 may determine a feed source cassette again according to the detection result of the document size sensor 11h, the updated sheet type, and the order information 6B after making setting that is not to print an image. In this case, the following processing continues to be performed.

It is premised that sheet information 6A illustrated in FIG. 10B is recorded in the sheet information storage unit 101 immediately after it is ascertained that the updated sheet type (“sheet type” of the sheet information 6A1) and the designated sheet type do not match each other.

The cassette determination unit 103 newly specifies sheet information 6A (sheet information 6A2) of which an order is highest after the sheet information 6A (sheet information 6A1) of the feed source cassette among other pieces of the sheet information 6A (the sheet information 6A2 and the sheet information 6A3) of which the size matches the detection result (A4) of the document size sensor 11h and the sheet types are “unregistered”. The cassette determination unit 103 determines a cassette 11 (cassette 112) corresponding to the newly specified sheet information 6A as a feed source cassette.

Meanwhile, if sheet information 6A cannot be newly specified among other pieces of the sheet information 6A (that is, if there is no other sheet information 6A of which an order is lower than the order of the sheet information 6A of the feed source cassette), the cassette determination unit 103 causes the touch panel display 10e to display that there is no sheet having a sheet type matching the designated sheet type and stops a copy job (a job that is being executed in this example).

The roller operation unit 104 and the sheet type acquisition unit 105 perform processing as in this embodiment. The sheet information 6A is updated in a case where the designated sheet type is acquired. Accordingly, as described above, the print setting unit 106 makes setting, which is to perform printing under a condition corresponding to the updated sheet type, for the print unit 10j if the updated sheet type (that is. “sheet type” of the updated sheet information 6A2) and the designated sheet type match each other. After that, an image is printed on a sheet by the print unit 10j.

If the updated sheet type and the designated sheet type do not match each other, the print setting unit 106 makes setting, which is not to print an image on the sheet having been already carried, for the print unit 10j. The cassette determination unit 103 newly specifies sheet information 6A again (that is, the cassette determination unit 103 determines a feed source cassette again).

Alternatively, if the updated sheet type and the designated sheet type do not match each other, the image forming apparatus 1 may temporarily stop copying after making setting that is not to print an image. Then, when a predetermined time (for example, 5 minutes) has passed after the image forming apparatus 1 temporarily stops copying, the image forming apparatus 1 may stop copying. Alternatively, the image forming apparatus 1 may return to Step #607 of FIG. 8 and perform processing, which determines a feed source cassette, again.

Further, the execution of other copying (hereinafter, described as a “subsequent job”) may be instructed from a user while the image forming apparatus 1 temporarily stops a copy job. In this case, the subsequent job may be executed as in the above-mentioned embodiment in preference to the copying (hereinafter, described as a “preceding job”) that is temporarily stopped.

Incidentally, the size and the sheet type of a sheet to be used in the subsequent job may match the size and the sheet type of a sheet used in the preceding job, respectively. For this reason, the subsequent job may also be temporarily stopped as with the preceding job.

At this time, each of the subsequent job and the preceding job can be resumed in a case where sheets having a size and a sheet type matching the size and the sheet type of a sheet to be used in the subsequent job are set in the cassette 11 again by a user. In this case, the following processing has only to continue to be performed while the execution of the subsequent job is temporarily stopped.

It is premised that a user has given a job, which copies the image of an A4 document to A4 plain paper after designating plain paper as a sheet type, as the preceding job and the subsequent job. Further, “sleet type” of the sheet information 6A1 is the updated sheet type. Furthermore, it is assumed that the sheet information 6A illustrated in FIG. 10B is recorded in the sheet information storage unit 101 immediately after it is ascertained that the updated sheet type and the designated sheet type do not match each other. Moreover, it is assumed that the preceding job and the subsequent job are temporarily stopped.

In a case where a user sets sheets in any one of the cassettes 11 again while the subsequent job is temporarily stopped, the residual quantity sensor 13 detects the residual quantity of the sheets of the cassette 11 and the sheet size sensor 12 detects the size of each sheet of the cassette 11 as in this embodiment.

In this example, a user sets plain paper having an A4 size in the cassette 114 again. The residual quantity sensor 134 detects the residual quantity of the sheets of the cassette 114. The sheet size sensor 124 detects that the size of each of the sheets set in the cassette 114 is A4.

The sheet state acquisition unit 102 receives the detection results of the sheet size sensors 12 as in this embodiment. The sheet state acquisition unit 102 updates “sizes” of the sheet information 6A of the cassettes 11 of the sheet size sensors 12 (hereinafter, described as “updated sizes”) on the basis of the results of the sheet size sensors 12. In this example, the sheet state acquisition unit 102 updates “size” of the sheet information 6A4 as illustrated in FIG. 10C.

The cassette determination unit 103 determines the cassette 11 corresponding to the updated sheet information 6A as a feed source cassette in a case where the updated size and the size of a document of the subsequent job match each other. The cassette determination unit 103 temporarily stops the subsequent job in a case where the updated size and the size of a document of the subsequent job do not match each other. Alternatively, the cassette determination unit 103 may stop the subsequent job. In this example, the cassette determination unit 103 determines the cassette 114 as a feed source cassette.

The roller operation unit 104 and the sheet type acquisition unit 105 perform processing as in this embodiment. In this example, the sleet type acquisition unit 105 updates “sheet type” of the sheet information 6A4 to “plain paper” as illustrated in FIG. 10D.

The sheet information 6A is updated in a case where the designated sheet type is acquired. Accordingly, as described above, the print setting unit 106 makes setting, which is to perform printing under a condition corresponding to the updated sheet type, for the print unit 10j if the updated sheet type and the designated sheet type match each other. After that, an image is printed on a sheet by the print unit 10j. That is, the temporary stop of the subsequent job is released and the subsequent job is executed.

Since the updated sheet type (that is, the sheet type of the updated sheet information 6A4) and the designated sheet type are plain paper and match each other in this example, the print setting unit 106 makes setting, which is to perform printing under a condition corresponding to plain paper, for the print unit 10j. Then, an image is printed on a sheet by the print unit 10j.

After the execution of the subsequent job is completed, the cassette determination unit 103 maintains the feed source cassette just as it is in a case where “size” and “sheet type” of the sheet information 6A of the feed source cassette match the size of a document of the preceding job and the designated sheet type, respectively. The cassette determination unit 103 temporarily stops the preceding job in a case where “size” and “sheet type” of the sheet information 6A of the feed source cassette do not match the size of the document of the preceding job and the designated sheet type, respectively. Alternatively, the cassette determination unit 103 may stop the preceding job. In this example, the cassette determination unit 103 maintains the cassette 114 as a feed source cassette.

Meanwhile, the size of the document of the preceding job ad the designated sheet type have only to be temporarily stored in the auxiliary storage 10d or the like when the execution of the subsequent job is instructed. Then, the size of the document of the preceding job and the designated sheet type have only to be called when the execution of the subsequent job is completed.

The roller operation unit 104 operates the pickup rollers 14 (pickup rollers 147 and 148) and the conveying rollers 16 at a normal speed. The sheet type acquisition unit 105 does not update a command, which is to be given to the sheet detection sensor 17, and the sheet information 6A.

The print setting unit 106 makes setting, which is to perform printing under a condition corresponding to the updated sheet type (“sheet type” of the sheet information 6A4) (that is, a condition corresponding to plain paper), for the print unit 10j. After that, an image is printed on a sheet by the print unit 10j. That is, the temporary stop of the preceding job is released and the preceding job is executed.

Meanwhile, in a case where sheet shortage occurs in the middle of printing in the automatic sheet-type detection processing, the residual quantity sensor 13 and the sheet state acquisition unit 102 have only to perform the same processing as when the above-mentioned sheet shortage occurs. The cassette determination unit 103 has only to perform the following processing instead of the processing as when the above-mentioned sheet shortage occurs.

That is, in a case where the sheet state acquisition unit 102 updates the sheet information 6A due to the occurrence of sheet shortage, the cassette determination unit 103 newly specifies sheet information 6A of which an order represented in the order information 6B is highest after the sheet information 6A of the feed source cassette among other pieces of the sheet information 6A of which “sizes” match the detection result (size) of the document size sensor 11h and the sheet types are “unregistered” when the execution of a copy job subjected to the current sheet shortage is instructed. Then, the cassette determination unit 103 determines a cassette 11 corresponding to the newly specified sheet information 6A as a feed source cassette.

As described above, in a case where the updated sheet type and the designated sheet type do not match each other in the automatic sheet-type detection processing, the image forming apparatus 1 stops a copy job without temporarily stopping the copy job, determines a feed source cassette again, or stops copying or determines a feed source cassette again after temporarily stopping copying for a predetermined time (hereinafter, described as “first countermeasure processing”, “second countermeasure processing”, and “third countermeasure processing”). Here, a user may determine one of the first countermeasure processing, the second countermeasure processing, and the third countermeasure processing, which is to be performed by the image forming apparatus 1, in advance.

For example, the user determines one of the first countermeasure processing, the second countermeasure processing, and the third countermeasure processing, which is to be performed by the image forming apparatus 1, through the administrator screen 5A illustrated in FIG. 1I. In a case where the user checks a checkbox 71A, the image forming apparatus 1 performs the first countermeasure processing when the updated sheet type and the designated sheet type do not match each other. In a case where the user checks a checkbox 72A, the image forming apparatus 1 performs the second countermeasure processing. In a case where the user checks a checkbox 73A, the image forming apparatus 1 performs the third countermeasure processing.

In addition, the user may determine a cassette 11, which is an object to be subjected to the automatic sheet-type detection processing, through the administrator screen 5A. For example, in a case where the user selects the radio button of “detect” of the cassette 01 and the radio button of “detect” of the cassette 02 as illustrated in FIG. 11, the image forming apparatus 1 performs the automatic sheet-type detection processing for the cassette 01 and the cassette 02.

Alternatively, the user may determine one of the first countermeasure processing, the second countermeasure processing, and the third countermeasure processing, which is to be performed by the image forming apparatus 1, for every job (that is, by job).

For example, when the user instructs a job to be executed from a terminal device by a PC print function or the like, the job settings screen 51B illustrated in FIG. 12A is displayed on the terminal device. When the user touches an advanced settings button 7B on the job settings screen 51B, the advanced settings screen 52B illustrated in FIG. 12B is displayed on the terminal device. The user checks any one of checkboxes 71B to 73B as in FIG. 11 to determine one of the first countermeasure processing, the second countermeasure processing, and the third countermeasure processing, which is to be performed by the image forming apparatus 1, for the job.

Alternatively, an administrative user who manages the image forming apparatus 1 may determine one of the first countermeasure processing, the second countermeasure processing, and the third countermeasure processing, which is to be performed by the image forming apparatus 1, for every user (that is, by user).

For example, the administrative user inputs the name and account of a user, which is allowed to perform the automatic sheet-type detection processing, in fields 74C and 75C on the administrator screen 5C of FIG. 13, respectively. The administrative user checks any one of checkboxes 71C to 73C as in FIG. 1I to determine one of the first countermeasure processing, the second countermeasure processing, and the third countermeasure processing that is allowed by the user to be performed by the image forming apparatus 1. Then, the administrative user registers the determined countermeasure processing in the image forming apparatus 1. If a user, which logs on to the image forming apparatus 1, has been registered in the image forming apparatus 1, the user performs the processing, which is determined by the administrative user, as the automatic sheet-type detection processing.

The entire image forming apparatus 1 or the configuration of the respective parts thereof, the contents of the processing, the order of the processing, the configuration of data, and the like can be appropriately modified according to the purpose of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a plurality of trays in which sheets are set;
a printer, and
a hardware processor that determines a first tray, which is one tray of the plurality of trays, in preference to a second tray, which is another tray of the plurality of trays, among the plurality of trays as a feed source tray feeding the sheets to the printer in a state where first sheets of which types are determined are set in the first tray as the sleets, second sheets of which types are not determined are set in the second tray as the sheets, and both the first and second sheets are capable of satisfying a condition allowing an image to be printed.

2. The image forming apparatus according to claim 1, further comprising
a conveyor that conveys the sheets from the feed source tray determined by the hardware processor to the printer.

3. The image forming apparatus according to claim 1,
wherein the hardware processor determines the first tray in preference to the second tray as the feed source tray in the state and further in a case where a type of a printing destination sheet on which the image is to be printed is not designated.

4. The image forming apparatus according to claim 1,
wherein an order of priority is given to each of the plurality of trays in advance, and
in the state and further in a case where there are a plurality of residual trays as the first trays in which the first sheets remain, the hardware processor determines a residual tray of which the order of priority is the highest among the plurality of residual trays as the feed source tray.

5. The image forming apparatus according to claim 1,
wherein an order of priority is given to each of the plurality of trays in advance, and
the hardware processor determines a second residual tray of which the order of priority is the highest among a plurality of second residual trays as the feed source tray in a second state where the first sheets are set in the first tray as the sheets, the second sheets are set in the second tray as the sheets, and only the second sheets are capable of satisfying the condition, and further in a case where a type of a printing destination sheet on which the image is to be printed is designated and there are a plurality of the second residual trays as the second trays in which the second sheets remain.

6. The image forming apparatus according to claim 5, further comprising:
a sensor that determines a type of the second sheets while the second sheets are conveyed from the second tray to the printer,
wherein the printer prints the image in a case where it is ascertained that the type determined by the sensor and the designated type match each other, and does not print the image in a case where it is ascertained that the type determined by the sensor and the designated type do not match each other.

7. The image forming apparatus according to claim 6,
wherein the hardware processor determines a second residual tray of which the order of priority is the highest among the plurality of second residual trays as the feed source tray when a predetermined time has passed after it is ascertained that the type determined by the sensor and the designated type do not match each other.

8. The image forming apparatus according to claim 7,
wherein when a new instruction for printing a new image is given to the image forming apparatus by the time the predetermined time passes, the hardware processor determines the first tray in preference to the second tray as the feed source tray to print the new image in a third state where the first sheets are set in the first tray, the second sheets are set in the second tray, and both the first and second sheets are capable of satisfying a new condition allowing the new image to be printed, and determines the second tray as the feed source tray to print the new image in a fourth state where at least the second sheets are set in the second tray and only the second sheets are capable of satisfying the new condition and in a case where a new type of a printing destination sheet on which the new image is to be printed is designated.

9. The image forming apparatus according to claim 8,
wherein the sensor determines a type of the second sheets conveyed from the determined second tray to the printer to print the new image, and
the hardware processor determines the determined second tray as the feed source tray to print the image in a case where the second sheets of the determined second tray satisfy the condition, and the type of the second sheet of the determined second tray, which is determined by the sensor, and the designated type match each other.

10. The image forming apparatus according to claim 7, further comprising
a display that displays a screen used to designate one of first countermeasure processing, second countermeasure processing, and third countermeasure processing to be performed by the hardware processor,
wherein in a case where it is ascertained that the type determined by the sensor and the designated type do not match each other, the hardware processor determines a second residual tray of which the order of priority is the highest among the plurality of second residual trays as the feed source tray again when the first countermeasure processing is designated on the screen, determines the feed source tray after the predetermined time passes after it is ascertained that the type determined by the sensor and the designated type do not match each other when the second countermeasure processing is designated, and does not determine the feed source tray since printing of the image is stopped when the third countermeasure processing is designated.

11. The image forming apparatus according to claim 1,
wherein the condition is a size of the sheet.

12. A tray determination method of determining a feed source tray, which feeds sheets to a printer, among a plurality of trays in which the sheets are set, the tray determination method comprising
determining a first tray, which is one tray of the plurality of trays, in preference to a second tray, which is another tray of the plurality of trays, as the feed source tray in a state where first sheets of which types are determined are set in the first tray as the sheets, second sheets of which types are not determined are set in the second tray as the sheets, and both the first and second sheets are capable of satisfying a condition allowing an image to be printed.

13. A non-transitory recording medium storing a computer readable computer program that is used to control an image forming apparatus including a plurality of trays in which sheets are set and a printer, the computer readable computer program causing the image forming apparatus to perform
determining a first tray, which is one tray of the plurality of trays, in preference to a second tray, which is another tray of the plurality of trays, among the plurality of trays as a feed source tray feeding the sleets to the printer in a state where first sheets of which types are determined are set in the first tray as the sheets, second sheets of which types are not determined are set in the second tray as the sheets, and both the first and second sheets are capable of satisfying a condition allowing an image to be printed.
